(19) United States
(12) Patent Application Publication
(10) Pub. No.: US 2012/0115405 A1
(43) Pub. Date: May 10, 2012

(54) DOUBLE-SIDED PRESSURE-SENSITIVE ADHESIVE TAPE AND POLISHING MEMBER

(75) Inventors: Shuuhei Yamamoto, Ibaraki-shi (JP); Koichi Ikeda, Ibaraki-shi (JP); Kazuyuki Yagura, Ibaraki-shi (JP)

(73) Assignee: NITTO DENKO CORPORATION, Osaka (JP)

(21) Appl. No.: 13/288,143

(22) Filed: Nov. 3, 2011

(30) Foreign Application Priority Data
Nov. 5, 2010 (JP) 2010-249070

(51) Int. Cl. C09J 7/02; B32B 25/00; B24D 11/00; B32B 27/04

(52) U.S. Cl. 451/533; 428/41.8; 428/41.3; 428/41.5

(57) ABSTRACT

A double-sided pressure-sensitive adhesive tape 10 according to an embodiment of the present invention includes: a first pressure-sensitive layer 30 that serves as a pressure-sensitive adhesive surface to a surface plate; a second pressure-sensitive adhesive layer 40 that serves as a pressure-sensitive adhesive surface to a polishing member; and a substrate 20 between the first pressure-sensitive adhesive layer 30 and the second pressure-sensitive adhesive layer 40. In the double-sided pressure-sensitive adhesive layer 10 having such a layer structure, the loop tack adhesive strength of the first pressure-sensitive adhesive layer 30 is 16 N/50 mm or less.

### TECHNICAL FIELD

The present invention relates to a double-sided pressure-sensitive adhesive tape for fixing, to a surface plate, a polishing member used for polishing a member to be polished, such as glass for liquid crystal displays.

### BACKGROUND ART

Polishing apparatuses for polishing the surfaces of glass for liquid crystal displays (LCDs), silicon wafers, and hard disk substrates, etc., have been conventionally known. In the polishing apparatus, a double-sided pressure-sensitive adhesive tape is used for fixing, to a surface plate, a polishing pad for supporting a member to be polished, or for fixing an abrasive cloth to a polishing surface.

For example, glass for LCDs has recently been growing in size with the LCDs growing in size. Polishing pads and abrasive cloths (hereinafter, the polishing pad and the abrasive cloth are collectively referred to as a polishing member in some cases) used in polishing apparatuses, which are used for polishing large-sized members to be polished, have also been growing in size, and accordingly a double-sided pressure-sensitive adhesive tape with a large width is needed to meet the a demand for fixing, to a surface plate, the large-sized polishing pads or abrasive cloths. For example, a double-sided pressure-sensitive adhesive tape having a substrate film width of 2 m or more has been developed as a wide double-sided pressure-sensitive adhesive tape.

### Patent Document

[Patent Document 1] Japanese Patent Application Publication No. 2010-90359

### DISCLOSURE OF THE INVENTION

### Problem to be Solved by the Invention

With a double-sided pressure-sensitive adhesive tape growing in size, it becomes more difficult to handle the double-sided pressure-sensitive adhesive tape. Accordingly, it becomes difficult to determine a position where one of the adhesive surfaces of a double-sided pressure-sensitive adhesive tape is to be adhered to a surface plate, the other of the adhesive surfaces of the double-sided pressure-sensitive adhesive tape having been adhered to a polishing member. Accordingly, it is sometimes required to restick the double-sided pressure-sensitive adhesive tape in order to be adhered to a predetermined position. In this case, it is difficult to restick a conventional double-sided pressure-sensitive adhesive tape because the tape has strong adhesive strength to a surface plate. In addition, when a double-sided pressure-sensitive adhesive tape once adhered to a surface plate has been peeled off, the adhesive of the tape is left on the surface of the surface plate, and hence it is difficult to restick the double-sided pressure-sensitive adhesive tape. When it cannot be performed to restick a double-sided pressure-sensitive adhesive tape, and which finally leads to a failure in sticking the tape, it is needed to replace a polishing member. In this case, there is the problem that the loss is large because a polishing member becomes expensive with it growing in size.

The present invention has been made in view of such an issue, and a purpose of the invention is to provide a technique in which it is made easy to restick, in particular, a large-sized (large in area, large in width) double-sided pressure-sensitive adhesive tape when a polishing member is fixed to a surface plate by using the tape.

### Means for Solving the Problem

An embodiment of the present invention is a double-sided pressure-sensitive adhesive tape. The double-sided pressure-sensitive adhesive tape comprises: a substrate; a first pressure-sensitive adhesive layer provided on one of the surfaces of the substrate; a second pressure-sensitive adhesive layer provided on the other of the surfaces of the substrate; and a release liner laminated on the first pressure-sensitive adhesive layer and/or the second pressure-sensitive adhesive layer, in which the loop tack adhesive strength of the first pressure-sensitive adhesive layer to a stainless plate is 16 N/50 mm or less.

According to the double-sided pressure-sensitive adhesive tape of this embodiment, after the first pressure-sensitive adhesive layer has been adhered to a surface plate while a polishing member is being fixed to the second pressure-sensitive adhesive layer, the first pressure-sensitive adhesive layer can be easily peeled off from the surface plate when it is needed to restick the first pressure-sensitive adhesive layer or to correct the position where the adhesive layer has been adhered.

In the double-sided pressure-sensitive adhesive tape according to the aforementioned embodiment, the first pressure-sensitive adhesive layer may be a rubber-based pressure-sensitive adhesive layer containing a natural rubber and/or a synthetic rubber as the major component. The second pressure-sensitive adhesive layer may be an acrylic pressure-sensitive adhesive layer containing an acrylic polymer as the major component. The acrylic polymer may contain (meth)acrylic acid alkyl ester as the monomer major component. The first pressure-sensitive adhesive layer may be to be fixed, in a removable manner, to the surface plate in a polishing apparatus while a polishing member is being adhered to the second pressure-sensitive adhesive layer. The double-sided pressure-sensitive adhesive tape may be wound in a roll shape and the transverse length of the wound body may be 3000 mm or less.

Another embodiment of the present invention is a polishing member. To the surface of the polishing member, the second pressure-sensitive adhesive layer in the double-sided pressure-sensitive adhesive tape according to any one of the aforementioned embodiments has been adhered.

### ADVANTAGE OF THE INVENTION

According to the present invention, it can be easily performed to restick a double-sided pressure-sensitive adhesive tape when a polishing member is fixed to a surface plate by using the tape.

### BRIEF DESCRIPTION OF THE DRAWINGS

FIG. 1 is a schematic sectional view illustrating the configuration of a double-sided pressure-sensitive adhesive tape according to an embodiment; and

FIGS. 2(A) to 2(D) are schematic views illustrating a method of measuring a loop tack adhesive strength.

### REFERENCE NUMERALS

10 DOUBLE-SIDED PRESSURE-SENSITIVE ADHESIVE TAPE
20 SUBSTRATE
30 FIRST PRESSURE-SENSITIVE ADHESIVE LAYER
40 SECOND PRESSURE-SENSITIVE ADHESIVE LAYER
50a RELEASE LINER
50b RELEASE LINER

### BEST MODE FOR CARRYING OUT THE INVENTION

Hereinafter, embodiments of the present invention will be described with reference to the accompanying drawings.

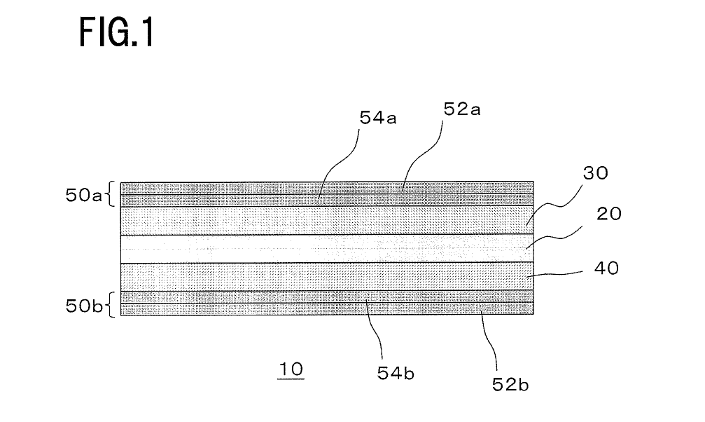

FIG. 1 is a schematic sectional view illustrating the configuration of a double-sided pressure-sensitive adhesive tape 10 according to an embodiment. The double-sided pressure-sensitive adhesive tape 10 comprises a substrate 20, a first pressure-sensitive adhesive layer 30, a second pressure-sensitive adhesive layer 40, a release liner 50a, and a release liner 50b. As one application, the double-sided pressure-sensitive adhesive tape 10 according to the present embodiment is used for fixing a polishing member, such as a polishing cloth, and polishing pad, to the surface plate in a polishing apparatus for polishing a member to be polished, such as glass for liquid crystal displays (LCDs).

### (Substrate)

The substrate 20 may be formed of, without limitation, a plastic film, paper, metallic foil, woven cloth, non-woven cloth, or the like; however, a plastic film is preferred in terms of strength and accuracy. Examples of the plastic film include: polyester films, such as polyethylene terephthalate (PET) and polybutylene terephthalate; and polyolefin films, such as polyethylene, and polypropylene. The thickness of the substrate is not particularly limited, but is, for example, 10 μm to 300 μm, and preferably 25 μm to 100 μm.

### (First Pressure-Sensitive Adhesive Layer)

The first pressure-sensitive adhesive layer 30 is one provided on one of the surfaces of the substrate 20 to be used for the adhesion to the surface plate in a polishing apparatus. The loop tack adhesive strength of the first pressure-sensitive adhesive layer 30 according to the present embodiment to a stainless plate is 16 N/50 mm or less, preferably 13 N/50 mm or less, and more preferably 10 N/50 mm or less (the minimum is 1 N/50 mm or more). In the double-sided pressure-sensitive adhesive tape according to the present invention, the first pressure-sensitive adhesive layer 30 can be easily peeled off from the surface plate in a polishing apparatus by making the loop tack adhesive strength of the adhesive layer 30 to be within the aforementioned range, when it is needed to restick the adhesive layer 30 or to collect the position where the adhesive layer 30 has been adhered after the adhesive layer 30 has been adhered to the surface plate. Such an effect becomes particularly remarkable when the width of the double-sided pressure-sensitive adhesive tape is made to be large (the width is 2100 mm or more and 3000 mm or less, preferably 2500 mm or more and 3000 mm or less). The loop tack adhesive strength can be determined by the later-described method. The thickness of the first pressure-sensitive adhesive layer 30 is, for example, 20 μm to 100 μm.

The components of the first pressure-sensitive adhesive layer 30 are not particularly limited, as far as the loop tack adhesive strength is 16 N/50 mm or less; however, the pressure-sensitive adhesive layer containing a natural rubber and/or a synthetic rubber as the major component is preferably used.

The synthetic rubber used in the first pressure-sensitive adhesive layer 30 is not particularly limited, but, for example, a styrene-isoprene-styrene block copolymer, styrene-butadiene-styrene block copolymer, hydrogen additives of the above styrene-based block copolymers, styrene-butadiene rubber (SBR), polyisoprene rubber (IR), polyisobutylene (PIB), and butyl rubber (IIR), etc., can be used. The natural rubber used in the first pressure-sensitive adhesive layer 30 is not particularly limited, but the natural rubber is used after being masticated with a mastication roll and being adjusted such that the Moony viscosity is, for example, approximately 10 to 100.

The first pressure-sensitive adhesive layer 30 may contain a tackifier in addition to the aforementioned natural rubber and/or synthetic rubber. Examples of the tackifier include a terpene phenol resin, rosin resin, and petroleum resin, etc. A use amount of the tackifier can be appropriately selected from a range in which the loop tack adhesive strength is 16 N/50 mm or less, and is, for example, 20 to 150 parts by mass based on 100 parts by mass of the natural rubber and/or the synthetic rubber. In a pressure-sensitive adhesive composition used for the first pressure-sensitive adhesive layer of the present invention, it is particularly preferable, in terms of adjusting the loop tack adhesive strength so as to be within a specific range, to use a natural rubber and a styrene-isoprene-styrene block copolymer in combination and further to contain phenol-modified rosin and an isocyanate crosslinking agent as essential components. This can be inferred that, because the phenol-modified rosin and the isocyanate crosslinking agent are likely to enter between the natural rubber and the synthetic rubber that are the major polymers, the phenol-modified rosin and the isocyanate crosslinking agent may act so as to exhibit a pressure-sensitive property while the hardness of a pressure-sensitive adhesive is being maintained.

The first pressure-sensitive adhesive layer 30 may contain, if necessary, appropriate additives, such as a softener, plasticizer, filler, anti-aging agent, and colorant, in addition to the aforementioned components.

### (Second Pressure-Sensitive Adhesive Layer)

The second pressure-sensitive adhesive layer 40 is one provided on the other of the surfaces of the substrate 20 to be used for the adhesion of a polishing member. The thickness of the second pressure-sensitive adhesive layer 40 is, for example, 20 μm to 100 μm.

The second pressure-sensitive adhesive layer 40 is not particularly limited, as far as the adhesive strength to a polishing member is sufficient; however, examples of the adhesive layer include a pressure-sensitive adhesive layer containing an acrylic polymer as the major component, and a heat-pressure-sensitive adhesive layer containing a thermoplastic polymer as the major component.

An acrylic polymer used in the second pressure-sensitive adhesive layer 40 contains, as a monomer unit, 50% by mass or more of (meth)acrylic acid alkyl ester having a C₁₋₂₀ alkyl group. In the acrylic polymer, the (meth)acrylic acid alkyl ester having a C₁₋₂₀ alkyl group may be used alone or in combination of two or more thereof. The acrylic polymer can be obtained by polymerizing (for example, solution polymerization, emulsion polymerization, or UV polymerization) the (meth)acrylic acid alkyl ester along with a polymerization initiator.

The ratio of the (meth)acrylic acid alkyl ester is having a C₁₋₂₀ alkyl group is 50% by mass or more to 99.9% by mass or less based on the total mass of the monomer components for preparing the acrylic polymer, preferably 60% by mass or more, and more preferably 70% by mass or more.

Examples of the (meth)acrylic acid alkyl ester having a C₁₋₂₀ alkyl group include, for example: (meth)acrylic acid C₁₋₂₀ alkyl esters, preferably (meth)acrylic acid C₂₋₁₄ alkyl esters, and more preferably (meth)acrylic acid C₂₋₁₀ alkyl esters, such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl, etc. Herein, the (meth)acrylic acid alkyl ester means an acrylic acid alkyl ester and/or a methacrylic acid alkyl ester, and all of the “(meth).” expressions have the same meaning.

Examples of the (meth)acrylic acid ester other than the (meth)acrylic acid alkyl ester include, for example: (meth)acrylic acid esters having a alicyclic hydrocarbon group, such as cyclopentyl(meth)acrylate, cyclohexyl(meth)acrylate, and isobornyl(meth)acrylate, etc.; (meth)acrylic acid esters having an aromatic hydrocarbon group, such as phenyl(meth)acrylate, etc.; and (meth)acrylic acid esters obtained from an alcohol derived from a terpene compound, etc.

For the purpose of modifying cohesive force, heat resistance property, and cross-linking property, etc., the acrylic polymer may contain, if necessary, another monomer component (copolymerizable monomer) that is copolymerizable with the (meth)acrylic acid alkyl ester. Accordingly, the acrylic polymer may contain a copolymerizable monomer along with the (meth)acrylic acid alkyl ester as the major component. A monomer having a polar group can be preferably used as the copolymerizable monomer.

Specific examples of the copolymerizable monomer include: carboxyl group-containing monomers, such as acrylic acid, methacrylic acid, carboxy ethyl acrylate, carboxy pentylacrylate, itaconic acid, maleic acid, fumaric acid, crotonic acid, and isocrotonic acid, etc.; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxylauryl, and (4-hydroxymethyl cyclohexyl)methyl methacrylate, etc.; acid anhydride group-containing monomers, such as maleic acid anhydride, and itaconic acid anhydride, etc.; sulfonic acid group-containing monomers, such as styrene sulfonic acid, allyl sulfonic acid, 2-(meth)acrylamide-2-methylpropanesulfonic acid, (meth)acrylamide propanesulfonic acid, sulfopropyl(meth)acrylate, and (meth)acryloyloxy naphthalene sulfonic acid, etc.; phosphate group-containing monomers, such as 2-hydroxyethyl acryloyl phosphate, etc.; (N-substituted)amide monomers, such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth))acrylamide, N-methoxymethyl(meth)acrylamide, and N-butoxymethyl(meth)acrylamide, etc.; succinimide monomers, such as N-(meth)acryloyloxy methylene succinimide, N-(meth)acryloyl-6-oxy hexamethylene succinimide, and N-(meth)acryloyl-8-oxy hexamethylene succinimide, etc.; maleimide monomers, such as N-cyclohexyl maleimide, N-isopropylmaleimide, N-lauryl maleimide, and N-phenyl maleimide, etc.; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide, etc.; vinyl esters, such as vinyl acetate and vinyl propionate, etc.; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, and N-vinyl morpholine, etc.; N-vinyl carboxylic acid amides; lactam monomers, such as N-vinyl caprolactam, etc.; cyanoacrylate monomers, such as acrylonitrile and methacrylonitrile, etc.; (meth)acrylic acid aminoalkyl monomers, such as (meth)acrylic acid aminoethyl, (meth)acrylic acid N,N-dimethylaminoethyl, (meth)acrylic acid N,N-dimethylaminoethyl, and (meth)acrylic acid t-butylaminoethyl, etc.; (meth)acrylic acid alkoxy alkyl monomers, such as (meth)acrylic acid methoxyethyl, and (meth)acrylic acid ethoxyethyl, etc.; styrene monomers, such as styrene and α-methylstyrene, etc.; epoxy group-containing acrylic monomers, such as (meth)acrylic acid glycidyl, etc.; glycol acrylic ester monomers, such as (meth)acrylic acid polyethylene glycol, (meth)acrylic acid polypropylene glycol, (meth)acrylic acid methoxy ethylene glycol, and (meth)acrylic acid methoxy polypropylene glycol, etc.; acrylic acid ester monomers having a heterocycle, halogen atom, silicon atom, or the like, such as (meth)acrylic acid tetrahydrofurfuryl, fluoride(meth)acrylate, and silicone(meth)acrylate, etc.; olefin monomers, such as isoprene, butadiene, and isobutylene, etc.; vinyl ether monomers, such as methyl vinyl ether, and ethyl vinyl ether, etc.; thioglycolic acid; vinyl esters, such as vinyl acetate, and vinyl propionate, etc.; aromatic vinyl compounds such as styrene, and vinyl toluene, etc.; olefins or dienes, such as ethylene, butadiene, isoprene, and isobutylene; etc.; vinyl ethers, such as vinyl alkyl ether, etc.; vinyl chloride; (meth)acrylic acid alkoxy alkyl monomers, such as (meth)acrylic acid methoxyethyl and (meth)acrylic acid ethoxyethyl, etc.; sulfonic acid group-containing monomers such as vinyl sulfonate sodium, etc.; imide group-containing monomers, such as cyclohexyl maleimide and isopropyl maleimide, etc.; isocyanate group-containing monomers, such as 2-isocyanate ethyl(meth)acrylate, etc.; fluorine atom-containing (meth)acrylates; and silicon atom-containing (meth)acrylates, etc. These copolymerizable monomers can be used alone or in combination of two or more thereof.

When the acrylic polymer contains the copolymerizable monomer along with the (meth)acrylic acid alkyl ester as the major component, carboxyl group-containing monomers can be preferably used. Among them, an acrylic acid can be preferably used. The use amount of the copolymerizable monomer is not particularly limited, but the copolymerizable monomer can be usually contained in an amount within a range of 0.1 to 30% by mass based on the total mass of the monomer components for preparing the acrylic polymer, preferably in an amount within a range of 0.5 to 20% by mass, and more preferably in an amount within a range of 1 to 15% by mass.

By containing the copolymerizable monomer in an amount of 0.1% by mass or more, a decrease in the cohesive force of an acrylic pressure-sensitive adhesive tape or sheet formed of an acrylic pressure-sensitive adhesive can be prevented and high shear force can be obtained. Further, by making the content of the copolymerizable monomer to be 30% by mass or less, it can be prevented that the cohesive force may become too high and the tackiness at normal temperature (25° C.) can be improved.

The acrylic polymer may contain, if necessary, a polyfunctional monomer in order to adjust the cohesive force of an acrylic pressure-sensitive adhesive to be formed.

Examples of the polyfunctional polymer include, for example: (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecane diol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, butyl di(meth)acrylate, and hexyl di(meth)acrylate, etc. Among them, trimethylolpropane tri(meth)acrylate, hexanediol di(meth)acrylate, and dipentaerythritol hexa(meth)acrylate can be preferably used. The polyfunctional (meth)acrylates can be used alone or in combination of two or more thereof.

The use amount of the polyfunctional monomer is changed depending on the molecular weight or the number of functional groups thereof, but the polyfunctional monomer is added in an amount within a range of 0.01 to 3.0% by mass based on the total mass of the monomer components for preparing the acrylic polymer, preferably in an amount within a range of 0.02 to 2.0% by mass, and more preferably in an amount within a range of 0.03 to 1.0% by mass.

If the use amount of the polyfunctional monomer exceeds 3.0% by mass based on the total mass of the monomer components for preparing the acrylic polymer, for example, the cohesive force of the acrylic pressure-sensitive adhesive may become too high and accordingly there are sometimes the cases where the adhesive strength may be decreased. On the other hand, if the use amount thereof is below 0.01% by mass, for example, there are sometimes the cases where the cohesive force of the acrylic pressure-sensitive adhesive may be decreased.

### <Polymerization Initiator>

In preparing the acrylic polymer, the acrylic polymer can be easily formed by a curing reaction using heat or ultraviolet rays with the use of a polymerization initiator, such as thermal polymerization initiator, photo-polymerization initiator (photo-initiator), or the like. In particular, a photo-polymerization initiator can be preferably used in terms of the advantage that a polymerization time can be shortened. The polymerization initiators can be used alone or in combination of two or more thereof.

Examples of the thermal polymerization initiator include, for example: azo polymerization initiators [for example, 2,2′-azobisisobutyronitrile, 2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, and 2,2′-azobis(N,N′-dimethyleneisobutylamidine)dihydrochloride, etc.]; peroxide polymerization initiators (for example, dibenzoyl peroxide, t-butyl permaleate, and lauroyl peroxide, etc.); and redox polymerization initiator, etc.

The use amount of the thermal polymerization initiator is not particularly limited, and only has to be within a conventional range in which it can be used as a thermal polymerization initiator.

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example: benzoin methyl ether, benzoin ethyl ether, benzoin propyl ether, benzoin isopropyl ether, benzoin isobutyl ether, 2,2-dimethoxy-1,2-diphenylethane-1-one [made by BASF, product name: IRGACURE 651], and anisole methyl ether, etc. Specific examples of the acetophenone photo-polymerization initiator include, for example: 1-hydroxycyclohexyl phenyl ketone [made by BASF, product name: IRGACURE 184], 4-phenoxy dichloroacetophenone, 4-t-butyl-dichloroacetophenone, 1-[4-(2-hydroxyethoxy)-phenyl]-2-hydroxy-2-methyl-1-propane-1-one [made by BASF, product name: IRGACURE 2959], 2-hydroxy-2-methyl-1-phenyl-propane-1-one [made by BASF, product name: DAROCUR 1173], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,1-propanedione-2-(o-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photo-polymerization initiator include, for example, benzyl dimethyl ketal, etc. Specific examples of the thioxanthone photo-polymerization initiator include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Examples of the acylphosphine photo-polymerization initiator include, for example: bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methylpropane-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

Among them, bis(2,4,6-trimethylbenzoyl)phenylphosphine oxide [made by BASF, product name: IRGACURE 819], bis(2,4,6-trimethylbenzoyl)-2,4-di-n-butoxyphenylphosphine oxide, 2,4,6-trimethylbenzoyl diphenylphosphine oxide [made by BASF, product name: Lucirin TPO], and bis(2,6-dimethoxybenzoyl)-2,4,4-trimethylpentylphosphine oxide, are particularly preferred.

The use amount of the photo-polymerization initiator is not particularly limited, but the photo-polymerization initiator is combined in an amount within a range of, for example, 0.01 to 5 parts by mass based on 100 parts by mass of the monomer components for preparing the acrylic polymer, preferably in an amount within a range of 0.05 to 3 parts by mass, and more preferably in an amount within a range of 0.08 to 2 parts by mass.

Herein, if the use amount of the photo-polymerization initiator is below 0.01 parts by mass, there are sometimes the cases where a polymerization reaction is insufficient. If the use amount thereof exceeds 5 parts by mass, there are sometimes the cases where, because the photo-polymerization initiator absorbs an ultraviolet ray, an ultraviolet ray may not reach the inside of the pressure-sensitive adhesive layer, thereby causing a decrease in the polymerization ratio, or making the molecular weight of the polymer to be generated to be small. Accordingly, the cohesive force of the pressure-sensitive adhesive layer to be formed becomes low, and when the pressure-sensitive adhesive layer is peeled off from a film, part of the adhesive layer is left on the film, thereby sometimes making it impossible to reuse the film. The photo-polymerization initiators may be used alone or in combination of two or more thereof.

Besides the aforementioned polyfunctional monomers, a cross-linking agent can also be used for adjusting the cohesive force. Commonly-used cross-linking agents can be used as the cross-linking agent. Examples of the cross-linking agents include, for example: epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. Among them, in particular, the isocyanate cross-linking agent and epoxy cross-linking agent can be preferably used.

Specific examples of the isocyanate cross-linking agent include: tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenylmethane triisocyanate, polymethylene polyphenyl isocyanate, and these adducts with polyols, such as trimethylolpropane, etc.

Examples of the epoxy cross-linking agent include: bisphenol A, epichlorohydrin type epoxy resin, ethyleneglycidylether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidyl amine, N,N,N′,N′-tetraglycidyl-m-xylylenediamine, and 1,3-bis(N,N′-diamine glycidyl aminomethyl)cyclohexane, etc. The use amount of each of these cross-linking agents is not particularly limited, but the cross-linking agent is contained in an amount within a range of, for example, 0.01 to 10 parts by mass based on 100 parts by mass of the acrylic polymer.

The pressure-sensitive adhesive layer containing the acrylic polymer as the major component may contain, if necessary, appropriate additives, such as a tackifier, softener, plasticizer, filler, anti-aging agent, and colorant, in addition to the aforementioned components.

As the tackifier, tackifiers, for example, such as a rosin tackifier, terpene tackifier, phenol tackifier, and petroleum tackifier, can be used.

A thermoplastic polymer to be used in the second pressure-sensitive adhesive layer 40 is not particularly limited, as far as a pressure-sensitive adhesive property is exhibited after being heated and melted; and a heat-pressure-sensitive adhesive having a composition in which a styrene block copolymer has been contained as a base polymer and a tackifier has been further combined therein can be preferably exemplified.

As the aforementioned styrene block copolymer, for example, a styrene-conjugated diene block copolymer can be preferably exemplified. As the styrene-conjugated diene block copolymer, an A-B-A type block copolymer is preferably used in which a styrene polymer block and a conjugated diene polymer block alternately exist. Specific examples of the styrene-conjugated diene block copolymer include a block copolymer of styrene and a conjugated diene, such as butadiene or isoprene, or a hydrogenated additive thereof. A styrene-butadiene-styrene block copolymer or a hydrogen additive thereof is preferred in terms of durability.

The content of a styrene polymer in such a styrene-conjugated diene block copolymer (hereinafter, referred to as a styrene content) is usually within a range of 10 to 40% by mass, and preferably within a range of 13 to 35% by mass. In addition, the mass average molecular weight of the whole copolymer is preferably within a range of 50,000 to 700,000, and more preferably within a range of 100,000 to 400,000.

Examples of the aforementioned tackifier include, for example, a rosin resin, terpene resin, petroleum resin, hydrogenated petroleum resin, aliphatic hydrocarbon resin, and aromatic hydrocarbon resin, etc. Among them, it is preferable to use a styrene tackifying resin as one of essential components. In the case, the use amount of the styrene tackifying resin is within a range of 10 to 100 parts by mass based on 100 parts by mass of the styrene block copolymer, and preferably within a range of 20 to 70 parts by mass. Such combination is preferred because: the tackiness is small at room temperature and hence a position to which a polishing member is to be fixed can be easily determined, while the polishing member can be easily adhered by heating the second pressure-sensitive adhesive layer after the position has been determined. Additionally, it is preferable to use, in combination, another tackifier in addition to the aforementioned styrene tackifying resin, and in the case it is preferable to combine the tackifiers in a total amount (total amount of the styrene tackifying resin and the another tackifier) within a range of 40 to 200 parts by mass based on 100 parts by mass of the styrene block copolymer.

### (Release Liner)

The release liner 50a is laminated on the pressure-sensitive adhesive surface of the first pressure-sensitive adhesive layer 30 opposite to the substrate 20. The release liner 50a has a (A) polymer layer 52a and a (B) paper substrate layer 54a in the order from the exposed surface.

The (A) polymer layer 52a is selected from the group consisting of polyolefins including polyethylene, polypropylene, ethylene-propylene copolymer, or mixtures thereof. The thickness of the polymer layer 52a is within a range of, for example, 10 μm to 300 μm.

The (B) paper substrate layer 54a is selected from the group consisting of glassine paper, craft paper, and high-quality paper. The thickness of the paper substrate layer 54a is within a range of, for example, 50 μm to 200 μm. It is preferable that the surface of the paper substrate layer 54a near to the first pressure-sensitive adhesive layer 30 has been subjected to a release treatment by a release treatment agent, such as a silicone release agent.

The release liner 50b is laminated on the pressure-sensitive surface of the second pressure-sensitive adhesive layer 40 opposite to the substrate 20. The release liner 50b has a (C) polymer layer 52b and a (D) paper substrate layer 54b in the order from the exposed surface. The (C) polymer layer 52b and the (D) paper substrate layer 54b correspond to the (A) polymer layer 52a and the (B) paper substrate layer 54a of the release liner 50a, respectively, and accordingly description thereof will be omitted. Hereinafter, the release liner 50a and the release liner 50b are collectively referred to as a release liner 50 in some cases.

The width of the double-sided pressure-sensitive adhesive tape 10 according to the present embodiment is 1300 mm or more and 3000 mm or less, and preferably 1500 mm or more and 2800 mm or less, and more preferably 2100 mm or more and 2500 mm or less.

The double-sided pressure-sensitive adhesive tape 10 according to the present embodiment is preferably obtained by preparing a substrate or a release liner having a large width (preferably 2100 mm or more to 3000 mm or less, and more preferably 2500 mm or more to 3000 mm or less) and by applying a pressure-sensitive adhesive composition with a pressure-sensitive adhesive composition coating apparatus having a large width corresponding to the width of the substrate or the release liner. It is preferable to apply the composition by using an coating apparatus having a roll width of 2100 mm or more to 3000 mm or less, for example, a gravure coater, fountain die coater, lip coater, comma coater, etc. By collectively coating a pressure-sensitive adhesive layer having a large width with such a pressure-sensitive adhesive composition coating apparatus having a large width, the risk of poor appearance can be more reduced.

In the double-sided pressure-sensitive adhesive tape 10 according to the present embodiment, the first pressure-sensitive adhesive layer 30 is a pressure-sensitive adhesive surface used for the adhesion to the surface plate in a polishing apparatus, and the second pressure-sensitive adhesive layer 40 is one used for the fixation of a polishing member. Because the loop tuck adhesive strength of the first pressure-sensitive adhesive layer 30 to a stainless plate is 16 N/50 mm or less, the first pressure-sensitive adhesive layer 30 can be easily peeled off from the surface plate after the adhesive layer 30 has been adhered to the surface plate, while a polishing member is being fixed to the second pressure-sensitive adhesive layer 40. Further, in the double-sided pressure-sensitive adhesive tape 10 according to the present embodiment, the adhesive is hardly left when the first pressure-sensitive adhesive layer 30 is peeled off from a surface plate. Accordingly, when the double-sided pressure-sensitive adhesive tape 10, one of the surfaces of which a polishing member has been adhered to, is adhered to a surface plate, a position can be easily determined by resticking, if necessary, the double-sided pressure-sensitive adhesive tape 10 to the surface plate. As a result, a waste of a polishing member due to an adhesion failure of a double-sided pressure-sensitive adhesive tape can be suppressed in the course of adhering the polishing member to a surface plate, which finally leads to a reduction in the cost necessary for a process of polishing a member to be polished.

In the double-sided pressure-sensitive adhesive tape 10 according to the aforementioned embodiment, the release liner 50 is provided on each of the first pressure-sensitive adhesive layer 30 and the second pressure-sensitive adhesive layer 40; however, the release liner 50 may be provided on one of the first pressure-sensitive adhesive layer 30 and the second pressure-sensitive adhesive layer 40. In this case, a release liner, both the surface layers of which are subjected to a release treatment, can be used.

### EXAMPLES

Hereinafter, the present invention will be described in detail based on Examples, but the invention should not be limited at all by these Examples.

Table 1 shows the components and layer thicknesses, etc., of the double-sided pressure-sensitive adhesive tape with respect to each of Example 1, Example 2, and Comparative Example 1.

TABLE 1

| | | | | | COMPARATIVE |
|---|---|---|---|---|---|
| | | | EXAMPLE 1 | EXAMPLE 2 | EXAMPLE 1 |
| RELEASE LINER A | POLYMER | MATERIAL | POLYETHYLENE | POLYETHYLENE | POLYETHYLENE |
| (FIRST PRESSURE-SENSITIVE | LAYER | LAYER | 19 | 20 | 19 |
| ADHESIVE LAYER SIDE/ | | THICKNESS | | | |
| SURFACE PLATE SIDE) | | (μm) | | | |
| | PAPER | MATERIAL | GLASSINE PAPER | CRAFT PAPER | GLASSINE PAPER |
| | SUBSTRATE | BASIS | 55 | 70 | 55 |
| | LAYER | MASS (g/m²) | | | |
| FIRST PRESSURE-SENSITIVE | MATERIAL | | RUBBER-BASED | RUBBER-BASED | ACRYLIC |
| ADHESIVE LAYER | | | PRESSURE-SENSITIVE | PRESSURE-SENSITIVE | PRESSURE-SENSITIVE |
| | | | ADHESIVE | ADHESIVE | ADHESIVE |
| | LAYER THICKNESS (μm) | | 40 | 40 | 60 |
| SUBSTRATE | MATERIAL | | PET | PET | PET |
| | LAYER THICKNESS (μm) | | 75 | 75 | 75 |
| SECOND PRESSURE-SENSITIVE | MATERIAL | | ACRYLIC PRESSURE- | ACRYLIC PRESSURE- | RUBBER-BASED |
| ADHESIVE LAYER | | | SENSITIVE ADHESIVE | SENSITIVE ADHESIVE | PRESSURE-SENSITIVE |
| | | | | | ADHESIVE |
| | LAYER THICKNESS (μm) | | 60 | 60 | 40 |
| RELEASE LINER B | PAPER | MATERIAL | GLASSINE PAPER | CRAFT PAPER | GLASSINE PAPER |
| (SECOND PRESSURE-SENSITIVE | SUBSTRATE | BASIS | 55 | 70 | 55 |
| ADHESIVE LAYER SIDE/ | LAYER | MASS (g/m²) | | | |
| POLISHING MEMBER SIDE) | POLYMER | MATERIAL | POLYETHYLENE | POLYETHYLENE | POLYETHYLENE |
| | LAYER | LAYER | 19 | 20 | 19 |
| | | THICKNESS | | | |
| | | (μm) | | | |

### Example 1

### Production of Acrylic Pressure-Sensitive Adhesive Composition

Butyl acrylate (70 parts by mass), 2-ethylhexyl acrylate (30 parts by mass), acrylic acid (3 parts by mass), and 4-hydroxy butyl acrylate (0.05 parts by mass) were added to a mixed solvent containing 152 parts by mass of toluene, and 0.08 parts by mass of AIBN (azobisisobutyronitrile) were added thereto as a polymerization initiator. Thereafter, the mixture was subjected to a solution polymerization at 60° C. for 6 hours to obtain a polymer solution for acrylic pressure-sensitive adhesive (viscosity: 28 Pa*s, solid content: 40% by mass). The mass average molecular weight of the acrylic polymer in the polymer solution for acrylic pressure-sensitive adhesive was 440000. After 30 parts by mass of a polymerized rosin pentaerythritol ester (“Pensel D125” made by Arakawa Chemical Industries, Ltd.) was added based on 100 parts by mass of the acrylic polymer solid content in the prepared polymer solution for acrylic pressure-sensitive adhesive, isocyanate (Product name: “Coronate L” made by NIPPON POLYURETHANE CO., LTD., 2 parts by mass) was added thereto as a crosslinking agent to obtain an acrylic pressure-sensitive adhesive composition.

### <Production of Rubber-Based Pressure-Sensitive Adhesive Composition>

After 100 parts of a natural rubber (Moony viscosity: 75), 30 parts by mass of SIS (Product name: “Quintac 3460C” made by ZEON CORPORATION, radial SIS copolymer, styrene content: 25% by mass), 40 parts by mass of maleic anhydride modified C5, C9 resin (Product name: “Quintone D-2001” made by ZEON CORPORATION), 40 parts by mass of phenol-modified rosin (Product name: “SUMILITE PR1260N” made by SUMITOMO BAKELITE CO., LTD.), and 1 part by mass of a phenol anti-aging agent (Product name: “NOCRAC NS-6” made by OUCHI SHINKO CHEMICAL INDUSTRIAL CO., LTD.) were dissolved in toluene, 3 parts by mass of isocyanate (Product name: “Coronate L” made by NIPPON POLYURETHANE CO., LTD.) were added thereto as a crosslinking agent to prepare a rubber-based pressure-sensitive adhesive solution.

### <Production of Pressure-Sensitive Adhesive Layer>

A paper substrate made of glassine paper (basis mass: 55 g/m2), one surface of which a polymer layer (thickness: 19 μm) made of polyethylene had been laminated on, was prepared. The surface (exposed surface) of the polymer layer made of polyethylene was brought into contact with a cooling roll on which a semi-mat treatment had been performed. A release liner A was prepared by performing a release treatment by a silicone release agent on the surface of the paper substrate layer opposite to the surface on which the polymer layer had been laminated. A release liner B was prepared by the same procedures as in the release liner A. The width of each of the release liner A and the release liner B was 2500 mm.

A polyethylene terephthalate (PET) film having a thickness of 75 μm and a width of 2500 mm was prepared as a substrate.

The aforementioned rubber-based pressure-sensitive adhesive composition was applied on one of the surfaces of the substrate by using a pressure-sensitive adhesive coating apparatus (comma coater) having a coating width of 2500 mm, and was heated in an oven at 100° C. for 3 minutes to remove the solvent, thereby producing a laminated body A comprising a rubber-based pressure-sensitive adhesive layer (first pressure-sensitive adhesive layer) having a width of 2500 mm and a thickness after being dried of 40 μm.

Subsequently, the release liner A was laminated on the rubber-based pressure-sensitive adhesive layer by facing the surface of the release liner A near to the paper substrate layer (the surface subjected to a release treatment by a silicone release agent) to the surface of the rubber-based pressure-sensitive adhesive layer.

The acrylic pressure-sensitive adhesive composition was applied on the surface of the release line B near to the paper substrate layer (the surface subjected to a release treatment by a silicone release agent) with a pressure-sensitive adhesive coating apparatus (comma coater) having a coating width of 2500 mm, and was heated in an oven at 100° C. for 3 minutes to remove the solvent, thereby producing a laminated body B comprising an acrylic pressure-sensitive adhesive layer (second pressure-sensitive adhesive layer) having a width of 2500 mm and a thickness after being dried of 60 μm.

Subsequently, the laminated body A was laminated on the laminated body B by facing the surface of the laminated body A near to the substrate to the acrylic pressure-sensitive adhesive layer in the laminated body B, thereby obtaining the double-sided pressure-sensitive adhesive tape according to Example 1 (release liner A/rubber-based pressure-sensitive adhesive layer/PET film/acrylic pressure-sensitive adhesive layer/release liner B). The transverse length of the double-sided pressure-sensitive adhesive tape according to Example 1 is 2500 mm.

### Example 2

A double-sided pressure-sensitive adhesive tape was produced by the same procedures as in Example 1, except that a paper substrate layer, in which a polymer layer (thickness: 20 μm) made of polyethylene had been laminated on one of the surfaces of craft paper whose basis mass was 70 g/m², was used as a release liner, and a release liner subjected to a release treatment by a silicone release agent was used on the surface of the paper substrate layer opposite to the surface on which the polymer layer had been laminated. The polymer layer in this release liner was not brought into contact with a cooling roll subjected to a semi-mat treatment.

### Comparative Example 1

A double-sided pressure-sensitive adhesive tape according to Comparative Example 1 was produced by the same procedures as in Example 1, except that the acrylic pressure-sensitive adhesive layer was used as a first pressure-sensitive adhesive layer and the rubber-based pressure-sensitive adhesive layer was used as a second pressure-sensitive adhesive layer. That is, the double-sided pressure-sensitive adhesive tape according to Comparative Example 1 has a layer structure in which the first pressure-sensitive adhesive layer and the second pressure-sensitive adhesive layer in the double-sided pressure-sensitive adhesive tape according to Example 1 were replaced with each other.

### <Loop Tack Measuring Method>

The loop tack adhesive strength of the first pressure-sensitive adhesive layer in each of the double-sided pressure-sensitive adhesive tapes according to Example 1, Example 2, and Comparative example 1 was measured in the following manner.

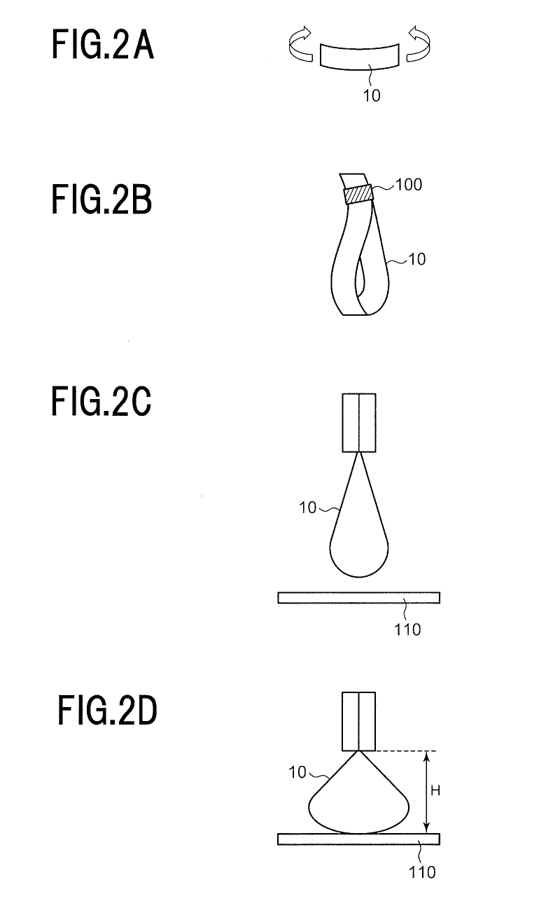

FIGS. 2 (A) to 2(D) are schematic views illustrating a method of measuring a loop tack adhesive strength. The release liner B in each of the double-sided pressure-sensitive adhesive tapes (50 mm×250 mm) was first peeled off, and the second pressure-sensitive adhesive layer in the each of the double-sided pressure-sensitive adhesive tapes, opposite to the first pressure-sensitive adhesive layer that was a surface to be measured, was backed with a PET film having a thickness of 25 μm.

Subsequently, a loop was formed as illustrated in FIG. 2(A), so that the first pressure-sensitive adhesive layer in the double-sided pressure-sensitive adhesive tape 10, which was to be a sample, was located outside. Then, one end of the double-sided pressure-sensitive adhesive tape 10 in the longitudinal direction and the other end thereof were overlapped with each other, as illustrated in FIG. 2(B), so that the portion 25 mm distant from the end was fixed with paper 100.

Subsequently, the double-sided pressure-sensitive adhesive tape 10 was arranged in a tensile tester such that the loop surface was located downward on the upper side of an adherend (stainless plate) 110, as illustrated in FIG. 2(C), followed by the peeling off of the release liner A near to the first pressure-sensitive adhesive layer.

Subsequently, the loop-shaped first pressure-sensitive adhesive layer in the double-sided pressure-sensitive adhesive tape 10 was brought into contact with the adherend (stainless plate) 110 by gradually moving the tape 10 downward, as illustrated in FIG. 2(D). Immediately after the distance H between the end of the double-sided pressure-sensitive adhesive tape 10 and the adherend 110 was reduced to 80 mm by further moving the tape 10 downward, the tape 10 was moving upward at a speed of 300 mm/min, so that the strength occurring when the tape 10 was peeled off from the adherend was measured. The results of measuring the loop tack adhesive strength of the double-sided pressure-sensitive adhesive tape according to each of Examples and Comparative Example are shown in Table 2. In addition, the results of checking whether the first pressure-sensitive adhesive layer was left on the adherend after the double-sided pressure-sensitive adhesive tape, that was to be a sample, had been peeled off from the adherend, i.e., so-called adhesive residue, are also shown in Table 2.

The aforementioned method of measuring a loop tack adhesive strength is in accordance with the method stipulated in the “PSTC-16 Loop Tack” in the evaluation standard of pressure-sensitive adhesive tape of “TEST METHODS 14th Edition” (Pressure Sentitive Tape Council); however, the sizes of the sample ware changed.

TABLE 2

| | EXAMPLE | EXAMPLE | COMPARATIVE |
|---|---|---|---|
| | 1 | 2 | EXAMPLE 1 |
| LOOP TACK | 5.6 | 9.5 | 18.3 |
| ADHESIVE | | | |
| STRENGTH (N/50 mm) | | | |
| TO STAINLESS | | | |
| PLATE | | | |
| ADHESIVE RESIDUE | NO | NO | YES |
| ON STAINLESS PLATE | | | |

As illustrated in Table 2, the loop tack adhesive strength of the double-sided pressure-sensitive adhesive tape in each of Example 1 and Example 2 to a stainless plate was 16 N/50 mm or less, and further 10 N/50 mm or less. Thereby, it has been confirmed that it is easy to restick a double-sided pressure-sensitive adhesive tape by peeling off the double-sided pressure-sensitive adhesive tape once adhered to an adherend. It has also been confirmed that adhesive residue never occurs on a stainless plate when the double-sided pressure-sensitive adhesive tape has been peeled off from the stainless plate. On the other hand, the loop tack adhesive strength in Comparative Example 1 to a stainless plate reaches 18.3 N/50 mm exceeding 16 N/50 mm. Thereby, it has been confirmed that it is difficult to restick the double-sided pressure-sensitive adhesive tape and that adhesive residue occurs on the stainless plate when the double-sided pressure-sensitive adhesive tape has been peeled off from the stainless plate.

1. A double-sided pressure-sensitive adhesive tape comprising:
a substrate;
a first pressure-sensitive adhesive layer provided on one of the surfaces of the substrate;
a second pressure-sensitive adhesive layer provided on the other of the surfaces of the substrate; and
a release liner laminated on the first pressure-sensitive adhesive layer and/or the second pressure-sensitive adhesive layer, wherein
the loop tack adhesive strength of the first pressure-sensitive adhesive layer to a stainless plate is 16 N/50 mm or less.

2. The double-sided pressure-sensitive adhesive tape according to claim 1, wherein
the first pressure-sensitive adhesive layer is a rubber-based pressure-sensitive adhesive layer containing a natural rubber and/or a synthetic rubber as the major component.

3. The double-sided pressure-sensitive adhesive tape according to claim 1, wherein
the second pressure-sensitive adhesive layer is an acrylic pressure-sensitive adhesive layer containing an acrylic polymer as the major component.

4. The double-sided pressure-sensitive adhesive tape according to claim 3, wherein
the acrylic polymer contains (meth)acrylic acid alkyl ester as the monomer major component.

5. The double-sided pressure-sensitive adhesive tape according to claim 1, wherein
the first pressure-sensitive adhesive layer is to be fixed, in a removable manner, to the surface plate in a polishing apparatus while a polishing member is being adhered to the second pressure-sensitive adhesive layer.

6. The double-sided pressure-sensitive adhesive tape according to claim 1 that is wound in a roll shape and has the transverse length of the wound body of 3000 mm or less.

7. A polishing member the surface of which the second pressure-sensitive adhesive layer in the double-sided pressure-sensitive adhesive tape according to claim 1 has been adhered to.
